(19) United States
(12) Patent Application Publication
(10) Pub. No.: US 2007/0024827 A1
(43) Pub. Date: Feb. 1, 2007

(54) Decorative display device with fibre-optic light source

(75) Inventor: Chun Chung Fung, Kwun Tong (HK)

Correspondence Address: LEYDIG VOIT & MAYER, LTD, 700 THIRTEENTH ST. NW, SUITE 300, WASHINGTON, DC, 20005-3960, US

(73) Assignee: Packway Industries Ltd., Kwun Tong (HK)

(21) Appl. No.: 11/193,466

(22) Filed: Aug. 1, 2005

(51) Int. Cl. G03B 21/00

(52) U.S. Cl. 353/122; 353/120

(57) ABSTRACT

A decorative display device includes a single-bulb light source, a transparency through which the light source projects to create an image upon a viewing area, and a fibre optic lead-in nearby the light source and receiving light therefrom.

### BACKGROUND OF THE INVENTION

The present invention relates to a decorative display device including a projected image and a fibre-optic light source. More particularly, although not exclusively, the invention relates to a decorative diorama having areas are illuminated by fibre optics, and including a projector for displaying an image.

It is known to use a projector to project images upon a screen. It is also known to transmit light fibre-optically to various locations about a decorative item. In a decorative article such as a diorama in which both a projected image and fibre optic light points are desired, it would seem logical to adopt both an image projector and a fibre optic light source—each of which would have its own light bulb. The quartz halogen light bulbs used in such devices are expensive to incorporate in the article during manufacture as well as to replace later on.

### OBJECT OF THE INVENTION

It is an object of the present invention to overcome or substantially ameliorate the above disadvantage.

### DISCLOSURE OF THE INVENTION

There is disclosed herein a decorative display device, comprising:
a single-bulb light source,
a transparency through which the light source projects to create an image upon a viewing area, and
a fibre optic lead-in nearby the light source and receiving light therefrom.

Preferably, the transparency is in the form of an annular wall illuminated internally by the light source.

Preferably, the transparency is mounted upon a turntable to rotate therewith.

Preferably, the projector further comprising an angled mirror located internally of the annular wall for reflecting light from the light source upon the annular wall.

Preferably, the turntable comprises peripheral teeth, and the projector further comprises an electric motor having an output pinion in mesh with the teeth.

Preferably, the single-bulb light source comprises a reflector box within which the bulb is located and having an opening between the bulb and the mirror.

Preferably, the reflector box has an opening between the bulb and the fibre-optic lead-in.

Preferably, the fibre-optic lead-in comprises a coupling to which a bundle of fibre-optic cables can be engaged.

Preferably, the coupling has an opening through which light from the bulb enters, and wherein there is provided across the opening a moving plate.

Preferably, the plate engages the turntable to rotate upon rotation of the turntable.

There is further disclosed herein a diorama incorporating the above-disclosed display device and including a screen which includes a viewing area.

Preferably, the diorama includes features fibre optically illuminated at numerous points by fibre-optic leads coupled to the lead-in.

### BRIEF DESCRIPTION OF THE DRAWINGS

A preferred form of the present invention will now be described by way of example with reference to the accompanying drawings, wherein:

FIG. 1 is a schematic perspective illustration of a diorama having a projector with a single-bulb light source,

FIG. 2 is a schematic perspective illustration of the projector,

FIG. 3 is a schematic perspective illustration of parts of the projector including a fibre-optic coupling,

FIG. 4 is another schematic perspective illustration of those parts of the projector shown in FIG. 3,

FIG. 5 is a schematic inverted perspective illustration of those parts of the projector shown in FIG. 3,

FIG. 6 is a schematic inverted perspective illustration of those parts of the projector shown in FIG. 3, with the light box being removed,

FIG. 7a is a schematic perspective illustration of the projector's light box and removable cover plate, and

FIG. 7b is a schematic perspective illustration of the projector's light box and removable cover plate with the single light bulb removed.

### DESCRIPTION OF THE PREFERRED EMBODIMENT

In the accompanying drawings there is depicted schematically a diorama 10 having an object such as a hollow mountain or mound 11 within which a display device in the form of a projector 15 is concealed. There would be provided in the object an opening through which an image can be projected by the display device. Of course the object might be a cottage or any other object that suits the particular diorama. A cottage for example might use one of its windows as an opening through which the image can be projected. The diorama 10 includes a display area screen 12 upon which a moving image 13 is projected by the projector 15. A number of fibre-optic tips 9 are located about the diorama, for example in trees, additional FIGS. 14, or upon the mountain 11 itself.

The projector 15 includes a single bulb 17 located within a light box 18 having reflective internal surfaces. The projector includes a chassis 25 to which the light box 18 is secured by means of a cover plate 29. Also mounted to the chassis 25 is a turntable 19 having a transparency drum 16 mounted thereon. The transparency drum would typically be in the form of a positive film, or opaque material having shaped cut-outs therein.

An angled mirror 24 is located within the drum 16 and reflects light from the bulb 17 through the transparency drum 16. The turntable 19 includes peripheral teeth 20. Mounted to the chassis 25 is an electric motor having an output pinion 23 in mesh with the peripheral teeth 20. Activation of the motor 22 causes rotation of the output pinion 23 to in turn cause rotation of the turntable 19. In the embodiment depicted, the moving image 13 of Santa Claus and a reindeer would move across the screen 12 due to rotation of the transparency drum 16 on which the image is provided.

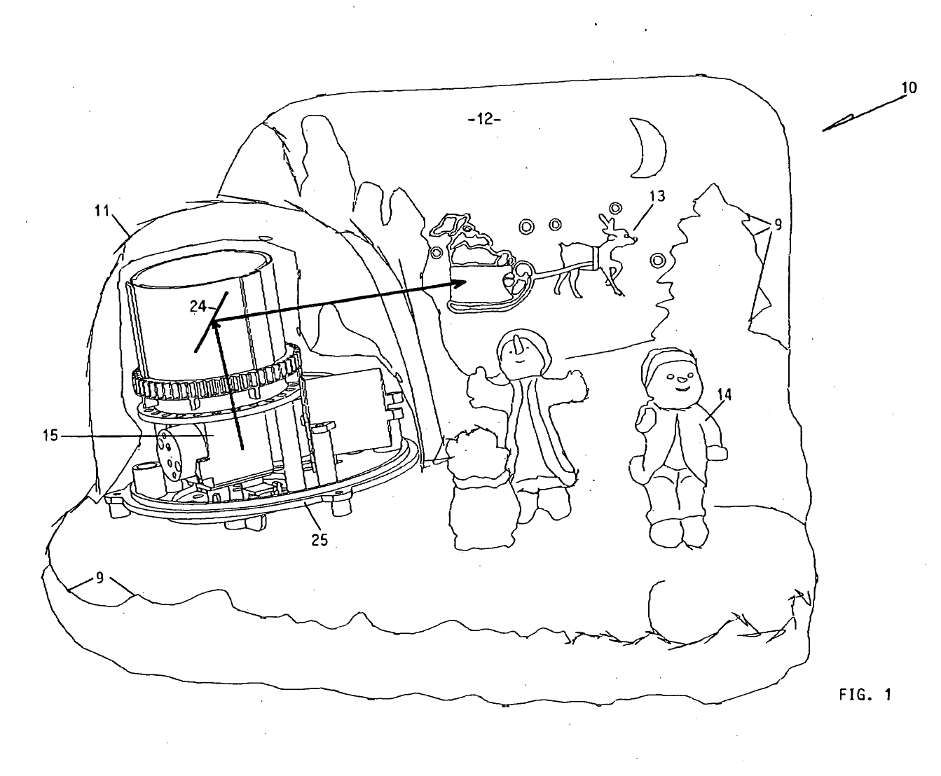

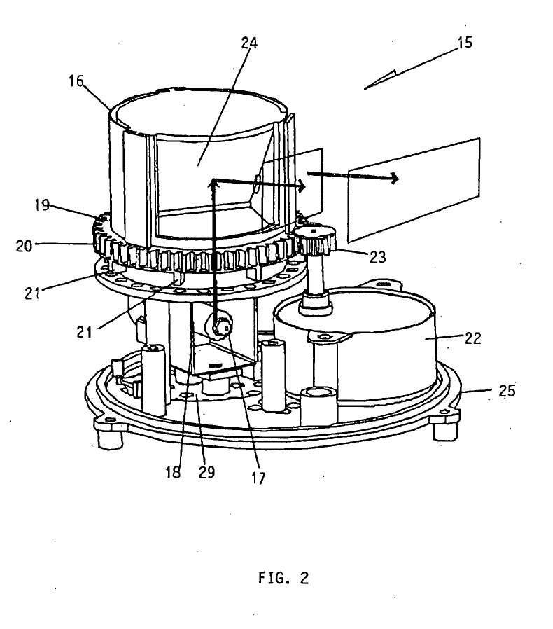

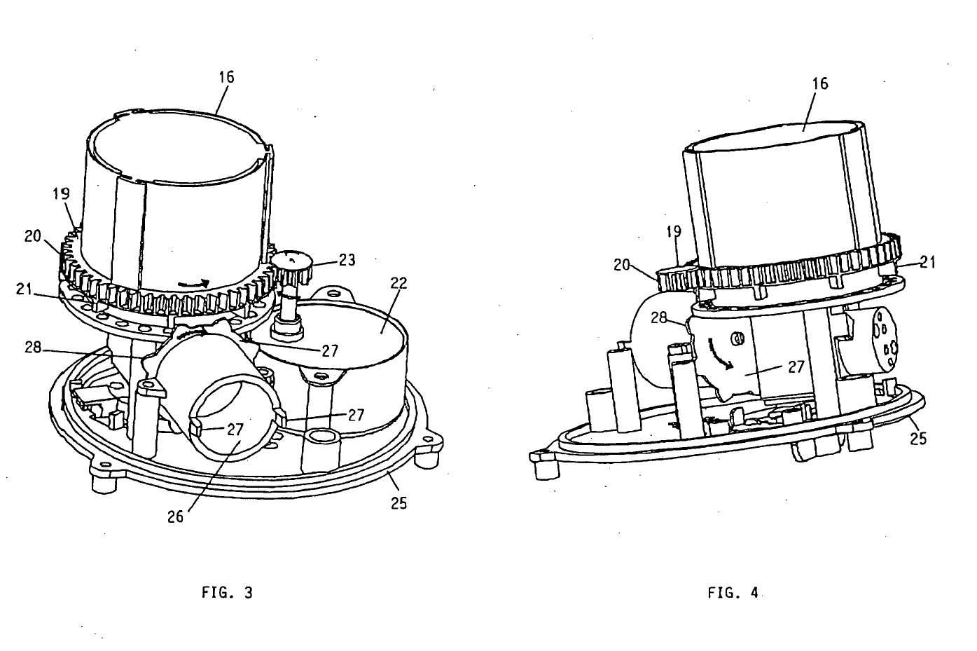

The light box, as best illustrated in FIGS. 7a and 7b, includes an upper opening 13 through which light from the bulb 17 passes upwardly to the mirror 24. It also includes an opening 31 in one side and through which light from the bulb 17 passes into a fibre optic coupling socket 26. The fibre optic coupling socket 26 has a pair of opposed resilient tabs 27 by which a plug (not shown) having a plurality of fibre optic cable ends therein would be retained in engagement with the coupling socket 26. Light from the single bulb 17 passing through the opening 31 into the socket coupling 26 would be received by the fibre optic cable ends for transmission to remote locations about the diorama as indicated by tips 9 in FIG. 1 for example.

Between the opening 31 and the coupling socket 26, there is provided a plate 27 having a number of radially extending tabs 28. The turntable 19 has a plurality of paddles 21 depending from its bottom surface. There are fewer paddles 21 than there are teeth 20 on the turntable 19. The paddles 21 engage the tabs 28 to pivot the plate 27 throughout an acute angle at which location the plate remains until the next paddle 21 engages its next tab 28. The plate 27 might be coloured translucent material with pie chart-like segments of differing colour. As the plate shifts from one angle to the next upon successive interaction of the paddles 21 with tabs 28, light of differing wavelength would impinge upon certain ones of the fibre optic cable ends at the coupling 26, so that the fibre optic tips 9 located about the diorama are illuminated in colour sequence.

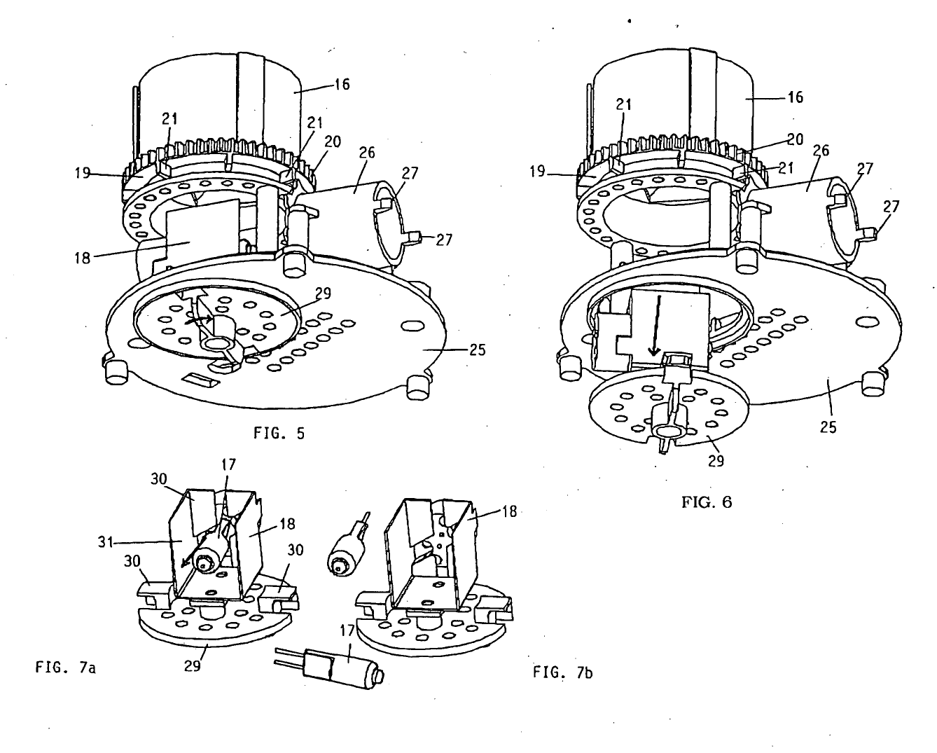

In order to replace the quartz halogen bulb 17, it can be removed together with the light box 18. To this end, the light box 18 is affixed to a bottom cover plate 29 having a pair of locking tabs. Removal of the cover plate 29 is a simple matter of twisting and turning as illustrated in FIGS. 5 and 6.

It should be appreciated that modifications and alterations obvious to those skilled in the art are not to be considered as beyond the scope of the present invention. For example, the coloured plate might be provided with light-transmissive and opaque areas to simply turn on and off certain ones of the fibre-optic tips 9 about the diorama as desired.

1. A decorative display device, comprising:
a single-bulb light source,
a transparency through which the light source projects to create an image upon a viewing area, and
a fibre optic lead-in nearby the light source and receiving light therefrom.

2. The display device of claim 1, wherein the transparency is in the form of an annular wall illuminated internally by the light source.

3. The display device of claim 2, wherein the transparency is mounted upon a turntable to rotate therewith.

4. The display device of claim 2, further comprising an angled mirror located internally of the annular wall for reflecting light from the light source upon the annular wall.

5. The display device of claim 3, wherein the turntable comprises peripheral teeth, and further comprising an electric motor having an output pinion in mesh with the teeth.

6. The display device of a claim 4, wherein the single-bulb light source comprises a reflector box within which the bulb is located and having an opening between the bulb and the mirror.

7. The display device of claim 6, wherein the reflector box has an opening between the bulb and the fibre-optic lead-in.

8. The display device of a claim 3, wherein the fibre-optic lead-in comprises a coupling to which a bundle of fibre-optic cables can be engaged.

9. The display device of claim 8, wherein the coupling has an opening through which light from the bulb enters, and wherein there is provided across the opening a moving plate.

10. The display device of claim 9, wherein the plate engages the turntable to rotate upon rotation of the turntable.

11. A diorama incorporating the display device of claim 1 and including a screen which includes a viewing area.

12. The diorama of claim 11, including features fibre optically illuminated at numerous points by fibre-optic leads coupled to the lead-in.
